(19) United States
(12) Patent Application Publication
(10) Pub. No.: US 2025/0055850 A1
(43) Pub. Date: Feb. 13, 2025

(54) SYSTEM FOR SECURE CONSENT VERIFICATION AND ACCESS CONTROL

(71) Applicant: Trust Elevate Ltd., London (GB)

(72) Inventors: Michal HARIS, Faringdon, Oxfordshire (GB); Rachel O'CONNELL, London, Greater London (GB)

(21) Appl. No.: 18/721,061

(22) PCT Filed: Dec. 15, 2022
(86) PCT No.: PCT/GB2022/053253

§ 371 Date: Jun. 17, 2024

(30) Foreign Application Priority Data
Dec. 17, 2021 (GB) 2118452.8

(51) Int. Cl. H04L 9/40

(52) U.S. Cl. CPC H04L 63/102

(57) ABSTRACT

A computer-implemented method controls, based on verified consent from a first individual, a data processing service in relation to usage of the service by a second individual. Access to the service, or processing and storage of data by the service, is controllable based on verified consent. A database includes encoded relationship facts, each specifying a consent relationship between two individuals identified by respective identifying information The relationship facts are encoded by applying one-way functions to the identifying information such that the identifying information is substantially irrecoverable from the encoded relationship facts. A request is received specifying an asserted consent relationship between the first and second individuals identified by first and second identifying information, and the one-way functions are to generate an encoded relationship assertion, and determining whether the encoded relationship assertion matches an encoded relationship fact. Operation of the service is then controlled depending on the determination.

The present invention relates to systems and methods for controlling use of a data processing service by a first individual based on verified consent obtained from a second individual. Particular examples relate to controlling access to or usage of online services by children by way of verified parental consent.

A variety of parental control systems have been developed to allow parents to limit access of their children to websites and applications when using devices such as personal computers and smartphones. However, these are often somewhat crude, and rely on software solutions that integrate at the operating system level or modify browser behaviour, e.g. to control what applications can be installed/run or what websites can be accessed. Furthermore, these are parent-driven, in that the parent has to proactively configure devices prior to use by children to set the relevant restrictions.

Online services have no control over these types of restrictions.

Often, however, an online service such as a website, online game and the like may wish to ensure that its services are only used appropriately, e.g. preventing access by children or tailoring content based on the age of the users. Such services cannot rely on parents having proactively configured parental control systems. Online services may also need to comply with data protection regulations governing how they collect, manage and dispose of user data, which in the case of underage users may require parental consent. While some services may implement a requirement to obtain consent from a parent before a child accesses a service, such systems are relatively easy to circumvent since there is no easy way of establishing that the second party providing the consent is the parent of the child in question (and thus able to consent to the child's use of the service or to data protection policies and other policies of the service), or that the second party is even an adult and not another child or the child themselves impersonating their parent. Some services require credit card details and may make a small charge to the credit card as a form of age verification, on the assumption that a credit card holder must be a legal adult, but that still does not prove that the credit card holder has parental responsibility for the child in question.

Embodiments of the invention aim to provide alternative approaches to verifying parental responsibility (or similar relationships where one individual is able to provide consent on behalf of another) to allow verified consent to be obtained, to address some of the drawbacks of existing approaches.

Accordingly, in a first aspect of the invention, there is provided a computer-implemented method of controlling, based on verified consent obtained from a first individual, operation of a data processing service in relation to usage of the data processing service by a second individual, the method comprising:
storing in a database a set of encoded relationship facts, each relationship fact specifying a consent relationship between two individuals identified by respective identifying information, wherein the relationship facts are encoded using an encoding process that applies one or more one-way functions to the identifying information such that the identifying information is substantially irrecoverable from the encoded relationship facts;
receiving a request specifying an asserted consent relationship between the first individual identified by first identifying information and the second individual identified by second identifying information;
applying the encoding process to the first and second identifying information to generate an encoded relationship assertion;
determining whether the encoded relationship assertion matches an encoded relationship fact in the database; and
controlling operation of the data processing service in dependence on the determination.

The step of determining whether the encoded relationship assertion matches an encoded relationship fact may include comparing the encoded relationship assertion to one or more encoded relationship facts, and determining whether the encoded assertion matches based on the comparison, e.g. by determining whether the encoded assertion corresponds to an encoded fact in accordance with one or more predetermined match criteria. The match criteria may determine when an encoded assertion is considered to “match” an encoded fact. The match criterion may, but need not necessarily, require exact correspondence of two identical encodings for a match. References to “matching” encodings shall be understood in this sense throughout, to encompass exact and inexact (e.g. fuzzy) matching. Thus, an encoded relationship assertion may be considered to “match” an encoded relationship fact if the encoded assertion is identical to the encoded fact, or if it is sufficiently similar to the encoded fact as determined by the match criterion. For example, a partial match may be sufficient (e.g. correspondence of particular components or substrings of the encoding) or the match criterion could specify a maximum distance threshold (e.g. numerical difference) between the encodings or between one or more components of the encodings. The encodings may be in the form of bit strings/numerical values (e.g. one or more hash values), allowing numerical or bitwise comparison in accordance with a similarity or distance metric to determine a match, with the match criterion comprising a similarity/distance threshold. The process may continue to evaluate encoded relationship facts in the database until a match is found or until all encoded facts have been evaluated and it is determined that none match the assertion.

References to information being “substantially irrecoverable” or similar should preferably be taken to mean that the source information cannot be recovered from the encoded information, at least not in a realistic or practical amount of time and/or using a practical quantity of computing resources, as is generally understood for one-way functions such as hash functions.

Each encoded relationship fact preferably comprises one or more hash values generated by the encoding process, wherein applying the encoding process comprises generating one or more hash values from the first and second identifying information for the asserted consent relationship, the determining step comparing the generated hash value(s) to the hash value(s) of the relationship facts stored in the database, and preferably determining whether they are identical or whether they match based on another match criterion.

The database preferably stores, for each encoded relationship fact: a first encoded element, comprising one or more hash values obtained by encoding identifying information associated with a consent giver individual using one or more one-way functions; a second encoded element, comprising one or more hash values obtained by encoding identifying information associated with a consent subject individual using one or more one-way functions; and an association linking the first encoded element and the second encoded element, the association identifying a predetermined consent relationship between the first and second individuals.

The method preferably comprises generating for the asserted consent relationship, corresponding first and second encoded elements (corresponding to those generated for the relationship facts and/or generated in the same manner), the determining step comprising: searching in the database for a first encoded element matching the first encoded element of the asserted consent relationship; in response to identifying the first encoded element, searching the database for a second encoded element linked to the first encoded element by an association indicating a consent relationship and matching the second encoded element of the asserted consent relationship; and identifying the asserted consent relationship as a verified consent relationship in response to finding the matching first and second encoded elements in the database.

The database may comprise a graph data structure linking each of a plurality of first encoded elements corresponding to identifying information of consent givers to one or more second encoded elements corresponding to identifying information of consent subjects.

The method may comprise further linking encoded elements, preferably consent subject elements, to source elements in the graph, the source elements indicating data sources from which encoded consent relationships represented in the graph were obtained.

The encoding process preferably comprises, for a given first individual being a consent giver and a given second individual being a consent subject: applying a first one-way function to identifying information associated with the first individual to generate a first hash value; and applying one or more further one-way functions to identifying information associated with the second individual to generate one or more further hash values. The method may comprise one or both of: generating a consent giver hash from the first hash value, optionally by concatenating the first hash value with an identifier identifying a version of the encoding process used; concatenating (at least) the further hash values to form a consent subject token representing the identifying information for the second individual. The database preferably associates a consent giver hash with one or more consent subject tokens indicating consent relationships between the consent giver and the consent subject(s).

Preferably, at least one of the further one-way functions is applied to identifying information associated with the second individual combined with the first hash value generated by the first one-way function. The method may comprise: generating a second hash value from a combination of the first hash value and a first piece of identifying information of the second individual; generating a third hash value from of a second piece of identifying information of the second individual; and combining (at least) the second and third hash values to generate a hash token representing the consent subject.

The identifying information associated with the first individual may comprise a unique identifier of the first individual, optionally a communications identifier such as a telephone number or email address; the first piece of identifying information of the second individual may be a date of birth of the second individual; and/or the third piece of identifying information may comprise a name of the second individual.

At least one hash value, preferably the third hash value, may be generated using a one-way function, preferably comprising a malleable hash function, whose output values are numerically closer for similar inputs than for dissimilar inputs.

Preferably, identifying information to which the encoding process is applied comprises a name having multiple name components, the encoding process applying a one-way function to the name whose output is invariant for variations in the order of the name components.

Identifying information to which the encoding process is applied may comprise a name, in which case the one-way function applied to the name may comprise computing a weighted sum of character values of (at least some but preferably all of) the characters in the name, wherein the weighted sum preferably applies a higher weight to characters that appear earlier in the name than to characters that appear later in the name. Identifying information to which the encoding process is applied may comprise a name having multiple name components, the method comprising computing individual weighted sums (e.g. as set out above) for each of a plurality of name components and generating the hash value based on combining, optionally summing, the individual weighted sums.

Preferably, the encoding process applies a non-malleable hash function to at least one element of identifying information, the at least one element optionally comprising identifying information of the first individual. When comparing encodings an exact match is preferably required for the identifying information of the first individual, whilst an inexact match (e.g. based on a difference threshold) may be allowed for one or more pieces of identifying information (preferably a name) of the second individual, e.g. based on use of the malleable hash function.

For inexact matches, a value may be determined indicating a strength of the match, which may be provided as an additional output and/or used in the controlling step.

The encoding process may comprise normalizing identifying information before applying a one-way function, wherein normalizing optionally comprises one or more of: removing one or more whitespace characters; converting letter characters in the identifying information to a consistent case (e.g. upper case/lower case); formatting the identifying information in accordance with a predetermined character representation format, for example a predetermined date format or telephone number format.

The encoding process may associate each encoded relationship fact or assertion with an encoding identifier specifying an encoding algorithm used to encode the relationship fact or assertion, wherein the determining preferably comprises comparing the relationship assertion to one or more relationship facts in the database having a matching encoding identifier, and wherein the encoding identifier optionally specifies a version of the encoding algorithm and/or identifies one or more hash functions used for generating encoded relationship facts or assertions.

Preferably, the database is indexed based on hash values of identifying information associated with consent givers, the determining step preferably using the index to identify one or more encoded relationship facts matching a hash value generated by the encoding process from identifying information of the first individual.

The encoded relationship facts are preferably stored in the database under control of a consent verification system, the consent verification system performing the step of determining whether the encoded relationship assertion matches an encoded relationship fact in the database and providing a control indication indicating whether the asserted consent relationship was verified as matching a relationship fact or not in dependence on the determination. The steps of receiving the request and applying the encoding process are preferably performed at a client system or device, the client system or device transmitting a query comprising the encoded relationship assertion to the consent verification system for verification over a data network.

The method may comprise, at the consent verification system, receiving the encoded relationship facts from one or more verification data sources over a data network and storing the encoded relationship facts in the database, the method preferably further comprising, at a verification data source: processing data in a database comprising personal information pertaining to individuals to identify consent relationships represented in the data; applying the encoding process to identifying information for the individuals to generate one or more encoded relationship facts; and transmitting the encoded relationship facts to the central verification system over a data network for storage in the database.

The controlling step preferably comprises providing a control indication to the data processing service, the operation of the data processing service controlled in dependence on the control indication, wherein the control indication is determined in dependence on whether the encoded relationship assertion matches an encoded relationship fact in the database.

The method may comprise obtaining, via a consent management interface, an indication of consent from the first individual in relation to usage of the data processing service by the second individual, wherein the control indication is further determined in dependence on the indication of consent. Preferably, the control indication is determined to indicate: verified consent in response to successful verification of the consent relationship and receipt of a positive consent indication from the first individual; and absence of verified consent in response to at least one of: failed verification of the consent relationship; absence of a positive consent indication from the first individual; a negative consent indication received from the first individual.

The controlling step may comprise: transmitting a message to the data processing service, the message including the control indication, and/or storing the control indication for later retrieval by the data processing service. The method preferably further comprises, at the data processing service, controlling usage of the data processing service by the second individual in dependence on the control indication, wherein controlling usage optionally comprises one or more of: permitting or denying access to the service by the second individual in dependence on the control indication; restricting usage of the service by the second individual in dependence on the control indication, optionally by restricting access to functions and/or content of the service;

and managing collection and/or storage of data pertaining to usage of the service by the second individual in dependence on the control indication.

The method may comprise, in response to verifying an asserted consent relationship between a consent giver and a consent subject, allowing the consent giver to manage stored consent indications indicating consent for usage of one or more data processing services by the consent subject, wherein managing stored consent indications optionally comprises granting, denying or revoking consent pertaining to usage of a data processing service by a consent subject. Consent indications may indicate one or more of: consent for a consent subject to access or use a data processing service or a part of the service; consent for the data processing service to store and/or process information associated with usage of the service by the consent subject.

The method may comprise providing a consent indication to a data processing service in response to a query from the data processing service, wherein the query is optionally generated by the data processing service in response to a consent subject attempting to access or use the service.

Preferably, the method comprises: receiving from a consent giver an indication to revoke consent for a consent subject relating to a data processing service; in response, transmitting a message to the data processing service indicating the revoked consent; and preferably further comprising, at the data processing service, controlling access or data processing relating to the consent subject in dependence on the received message, optionally by one of: denying future access to the service, and deleting data associated with the consent subject.

Consent relationships preferably comprise parental relationships, wherein a parental relationship indicates a consent relationship between a parent or legal guardian as consent giver and a child as consent subject.

In a further aspect, the invention provides a system for verifying consent relationships, comprising:
a database storing a set of encoded relationship facts, each relationship fact specifying a consent relationship between two individuals identified by respective identifying information, wherein the relationship facts are encoded using an encoding process that applies one or more one-way functions to the identifying information such that the identifying information is (at least substantially and/or for practical purposes) irrecoverable from the encoded relationship facts;
a request interface configured to receive a verification request, the verification request including an encoded consent relationship assertion asserting a consent relationship between a consent giver and a consent subject, the encoded assertion generated by applying the encoding process to identifying information associated with the consent giver and the consent subject; and
a request processing module configured to:
   determine whether the encoded relationship assertion matches (e.g. corresponds to in accordance with a predetermined match criterion) an encoded relationship fact in the database; and
   in response to determining that the encoded relationship assertion matches an encoded relationship fact in the database, outputting a control indication indicating successful verification of the asserted consent relationship.

The system may further comprise means for performing or participating in any method as set out above.

The invention also provides a system having means, optionally in the form of one or more processors and memory storing software code for execution by the processor(s), for performing any method as set out herein.

The invention further provides computer program, computer program product or computer-readable medium comprising software code adapted, when executed by one or more processing devices, to perform any method as set out herein.

Any feature in one aspect of the invention may be applied to other aspects of the invention, in any appropriate combination. In particular, method aspects may be applied to apparatus and computer program aspects, and vice versa.

Furthermore, features implemented in hardware may generally be implemented in software, and vice versa. Any reference to software and hardware features herein should be construed accordingly.

Preferred features of the present invention will now be described, purely by way of example, with reference to the accompanying drawings, in which:

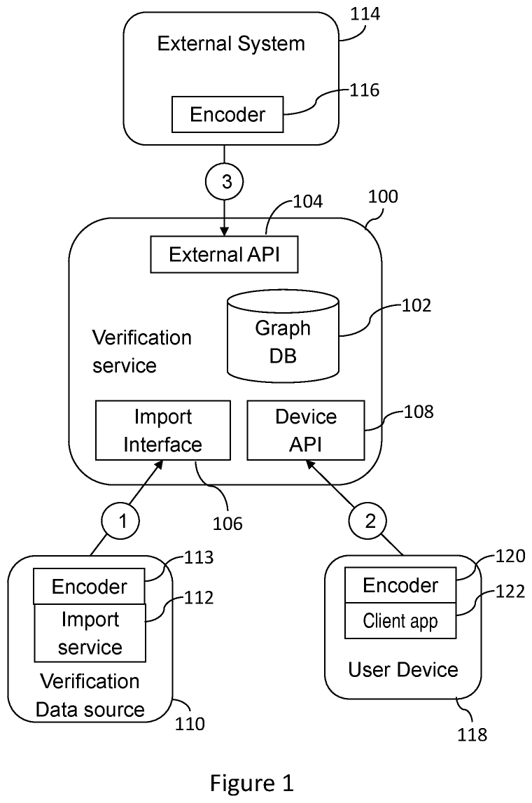

FIG. 1 illustrates a consent verification system in overview;

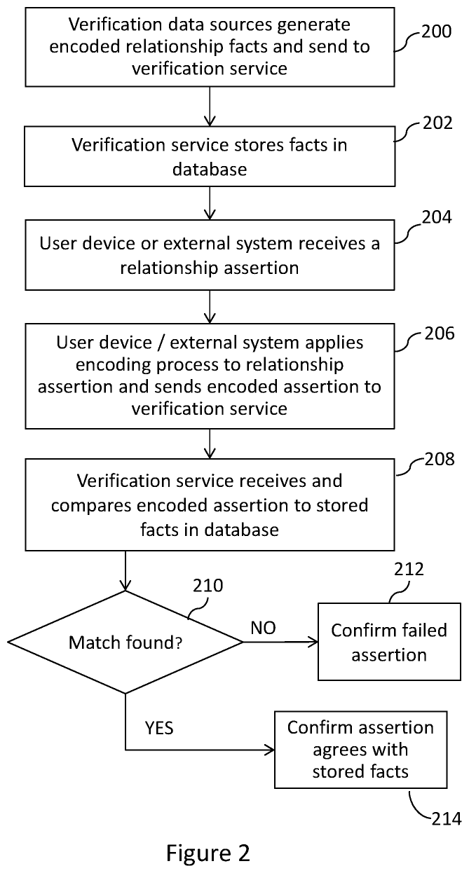

FIG. 2 illustrates a process performed by the consent verification system to verify consent relationships against a database of relationship information;

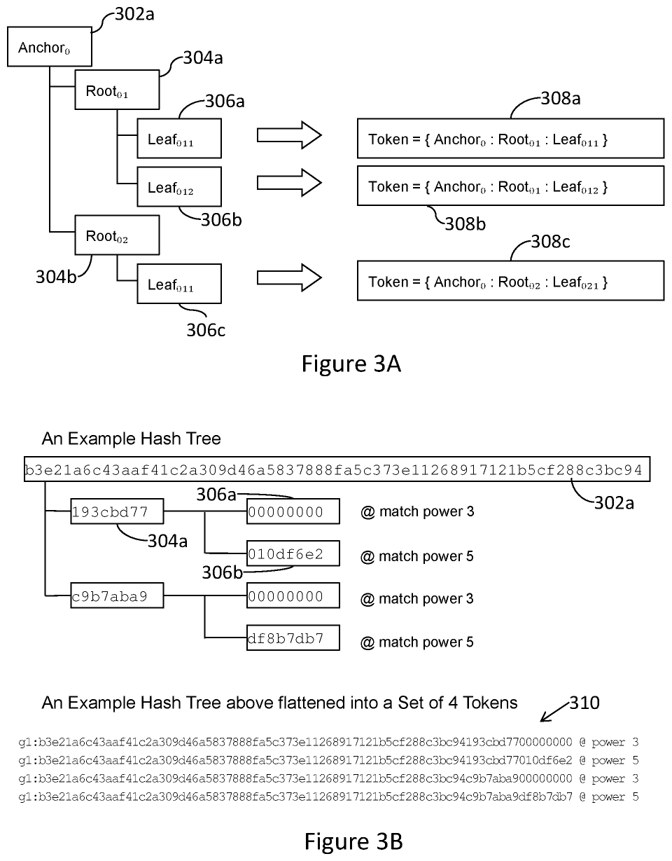

FIGS. 3A and 3B illustrate processes for encoding consent relationships so as to support secure verification;

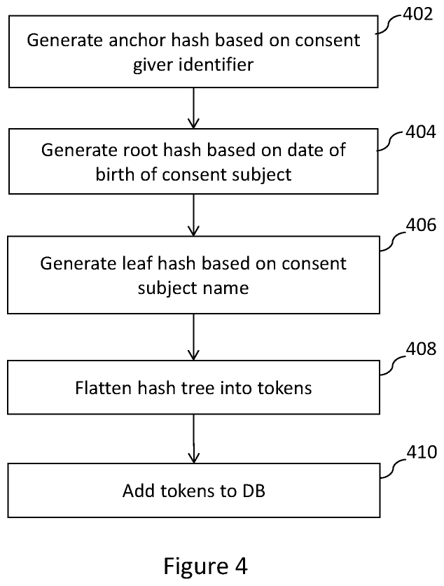

FIG. 4 illustrates a process for encoding consent relationships for storage in a verification database;

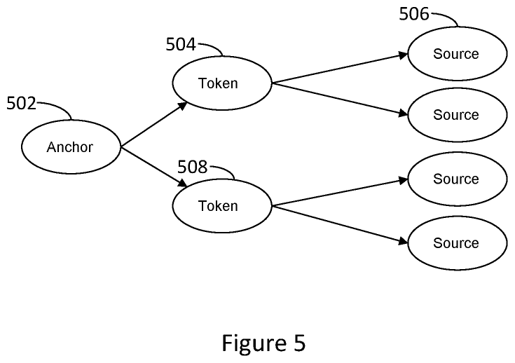

FIG. 5 illustrates a data storage representation used by the database;

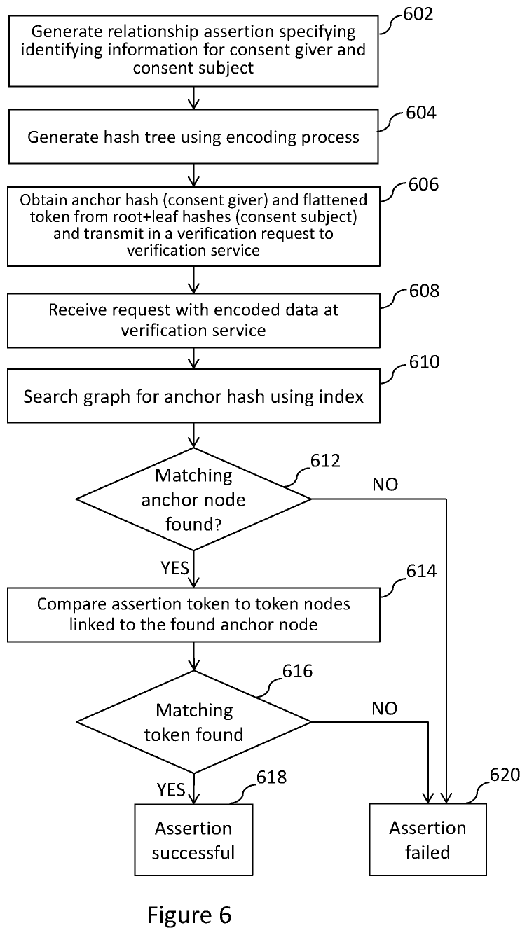

FIG. 6 illustrates a process for verifying an asserted consent relationship against the database;

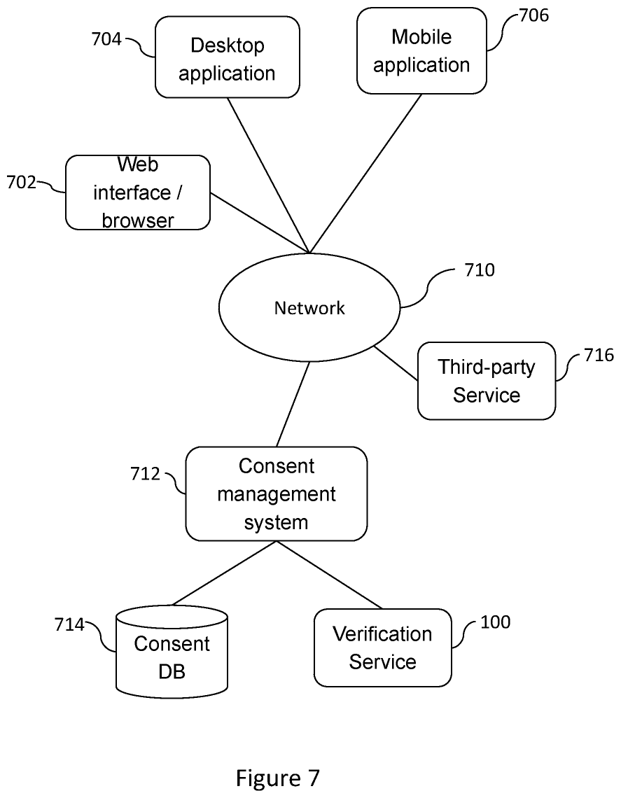

FIG. 7 illustrates integration of the consent verification system into a consent management system;

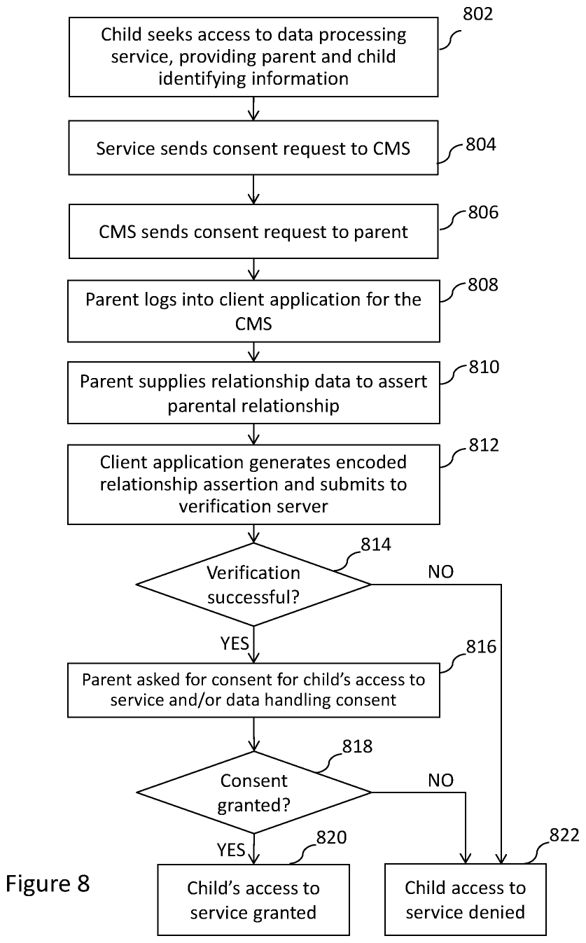

FIG. 8 illustrates an exemplary process flow for managing parental consent; and

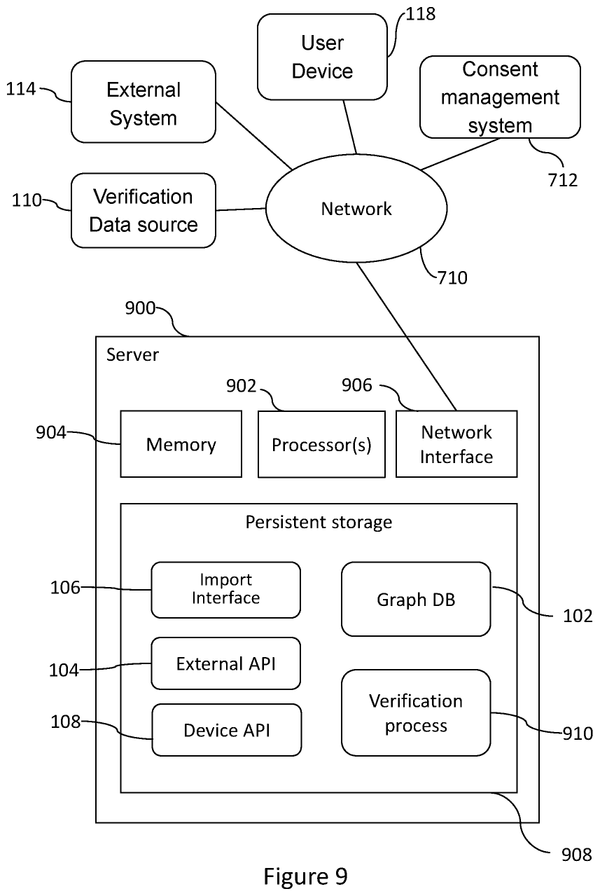

FIG. 9 illustrates a server device for implementing described processes.

### OVERVIEW

Embodiments of the invention provide systems and methods for generating, storing and comparing non-reversible, non-malleable tokens representing consent relationships, derived from personally identifiable information obtained from various data sources. Embodiments apply this method in the context of age verification and parental consent claims but the methods can be applied to other uses where there is a need to verify relationships between individuals or more generally to access highly sensitive data sources and extract useful information without extracting and storing the original data.

FIG. 1 illustrates a consent verification system implementing described techniques. The system includes a central verification service 100, implemented as software running on one or more servers.

The described consent verification mechanisms are based on relationship data which defines consent relationships between individuals. A typical example of a consent relationship is a parental relationship between a parent and their child. Relationship data comes in two forms: relationship facts, which define known consent relationships (e.g. parent-child relationships) which are accepted as true, and relationship assertions, which define relationships being asserted or claimed by some user (e.g. a user seeking to provide parental authorization for a child to access a service), and which require verification against the recorded relationship facts.

The verification service 100 receives relationship facts from one or more verification data sources 110 through an import interface 106 and stores the relationship facts in a database 102. The system also receives relationship assertions from one or more external systems 114 and/or one or more user devices 118 and evaluates the assertions against the stored relationship facts in the database 102. The verification process allows the system to confirm or reject assertions of the form “X is a parent of Y”, based on the data obtained from the verification data sources.

External systems 114 and user devices 118 connect to the system via respective APIs 104 and 108. External systems may be third party systems and services utilising the central verification service operated by a verification operator, for example by using a software development kit (SDK) provided by the verification operator to implement the client-side interface to the system. User devices may access the verification service directly to allow users to submit assertions and also provide/revoke consent once a consent relationship has been verified. To this end, user devices may be provided with a locally executable client application 122 (e.g. a smartphone app) that interfaces with the system via the device API 108 (though in alternative implementations the client application could be implemented as a web application running in a browser).

Different authentication schemes may be implemented to secure access by external systems on the one hand and user devices on the other hand. For example, device API 108 may support user authentication using credentials such as mobile telephone numbers/email addresses and passwords; whilst external systems 116 may be authenticated via external API 104 using allowed IP ranges and optionally access keys issued by the verification operator.

The system is designed such that every entry point (numbered 1-3 in FIG. 1) applies the same technique of encoding the relationship data into a set of “tokens” in such a way that tokens generated by the different entry points can be compared. The specific technique for generating a set of tokens from relationship data is referred to as tokenization and is described in more detail below.

FIG. 2 illustrates a process performed by the consent verification system in overview.

In step 200, relationship facts are received by the verification service from one or more verification data sources. Each relationship fact specifies a consent relationship between two individuals identified by respective identifying information. The facts are received in encoded form, generated at the data source using an encoding process that applies one or more one-way functions to the identifying information such that the identifying information is substantially irrecoverable from the encoded relationship facts. The encoding process will be described in more detail later.

In step 202, the encoded relationship facts are stored in a database. The structure of the database is described in more detail below.

In step 204, a verification request including a relationship assertion is received or generated at a user device or external system. The assertion specifies an asserted consent relationship between a first individual (the consent giver) identified by first identifying information and a second individual (the consent subject) identified by second identifying information. The request may typically relate to usage of a data processing service by a second individual (the consent subject), where that usage requires consent by the first individual (the consent giver). For example, the request may be generated in response to an attempt or request by the consent subject to access a data processing service (e.g. a website or other online service, an online gaming platform etc.), or the request may be generated in response to the consent giver proactively configuring consent for future access by the consent subject. The request may be sent by the data processing service to which the requested consent relates, or by another system (e.g. a consent management system for managing user consent as an intermediary between users and data processing services, as discussed in more detail later).

In step 206, the user device or external system applies the same encoding process (as used by the verification data sources) to the relationship assertion to generate an encoded relationship assertion encoding the first and second identifying information and sends the encoded assertion to the verification service.

The verification service receives the encoded assertion in step 208 and compares the encoded relationship assertion to the encoded relationship facts in the database.

If a match is found (test 210) between the assertion and a stored relationship fact, then the process determines that the assertion is valid and an indication is generated confirming that the encoded assertion matches an encoded relationship fact in the database (214) and thus the verification is successful. If no match is found (212) then an indication is generated confirming that the assertion failed. The system may transmit a response to the request indicating successful or failed verification to the requesting system/device and/or directly to the data processing service to which the consent relates.

The verification service may then continue to receive and verify further relationship assertions in the same manner.

Note steps 200 and 202 may be a one-off process performed to import relationship facts from data sources or may be repeated e.g. continuously/periodically as discussed later.

### Relationship Data and Data Sources

As discussed above, the consent verification process is based on relationship data in the form of relationship facts (e.g. accepted “true” consent relationships that are derived from an authoritative, trusted data source) and relationship assertions (claimed consent relationships that are to be verified against the facts).

Relationship facts are obtained from various data sources that contain data about individuals and define relationships between them, e.g. parent, legal guardian, etc. By their nature, such data sources are highly sensitive and maintaining data privacy is thus important. Such data sources may for example include commercial or government databases (e.g. databases used by health services, education services, social security services, or the like). Typically, the owners of such database would not be willing or able to make such data available to a verification service operator.

To address this, relationship facts are encoded at source, before leaving the systems controlled by the database owner. As shown in FIG. 1, embodiments implement an import interface 106 which cooperates with an import service 112 implemented locally at the verification data source 110. The import service extracts and encodes the required relationship data in such a way that the raw source data (e.g. personal and identifying data) is not exposed outside the verification data source.

The import service 112 may process the entire relevant contents of the data source on an initial load, and subsequently periodically crawls the data source looking for newly updated information. The information is analysed to identify relationship data that defines consent relationships (e.g. parent-child relationships). For example, this could be information in an education database identifying the parents of children attending a school and providing various identifying information for the parents and children. The import service then applies the encoding process 113 to the relationship data and sends the resulting encoded tokens to the verification service 100 for storage in database 102 via import interface 106. The encoding process is based on one-way functions (hash functions) which ensure that the source data is not recoverable from the tokens that are transmitted.

User devices 118 and external systems 114 then make assertions (relationship claims) which are tokenized using the same encoding process (employing the same set of hash functions) and are compared to the stored tokens generated by the import services.

The relationship data forming a relationship fact or assertion is based on identifying information relating to individuals. The term “identifying information” is used herein not only to refer to information that uniquely identifies individuals but also to other non-unique personal information pertaining to individuals that might be used (e.g. in conjunction with other information) to identify or represent individuals. Such identifying information can include, for example, names, email or postal addresses, telephone numbers, dates of birth, ages, usernames for online services etc.

In the following the individuals between whom a relationship is defined are referred to in general terms as the “consent giver” (the individual who can give consent. e.g. parent) and “consent subject” (the individual requiring consent from the consent giver, e.g. child). Such a relationship is referred to as a “consent relationship” which is in typical examples a parental relationship.

In an example, the relationship data available in a verification data source that is used to derive relationship facts provides at least the following data components:

### Component 1: Consent Giver ID

Typically a unique identifier for the consent giver; for example, a contact identifier such a mobile phone number or email address controlled by the consent giver.

### Component 2: Relationship

Information identifying the relationship of the consent giver (individual identified by component 1) to the consent subject (individual with date of birth and name as identified by components 3 and 4). For example, this could identify one of the following relationships:
AWPR—adult with parental responsibility which could be a parent, legal guardian or other.
SELF—in case the Relationship Data is about a non-adult who can legally give their own consent with regards to specific subjects and locations, e.g. in UK a person who is 13 or more can give their own consent with respect to data collection.

### Component 3: Consent Subject Date of Birth

Date of birth of the consent subject, e.g. the individual who is related by the relationship identified by component 2 to the consent giver identified by component 1

### Component 4: Consent Subject Name

Full name of the consent subject, i.e. the individual who is related by the relationship identified by component 2 to the consent giver identified by component 1

In a typical case of a Parent-Child relationship the data source may provide, for example:
(1) parent's mobile number
(2) relationship=parent
(3) date of birth of the child
(4) name of the child.

### Tokens and Tokenization

Relationship data is encoded by the system into “tokens”, which are irreversible, non-malleable strings that cannot be personally identified in any way. Specifically, the source data (e.g. components 1-4 identified above) is not recoverable from the tokens and the tokens do not include and are not linked to any other personally identifiable information. Tokens are generated by way of an encoding scheme using one or more hash functions applied to the source data components to generate the token.

Each token starts with a generation prefix which identifies the specific encoding scheme, in particular the specific set of hash functions, applied to the components of the relationship data. This allows for evolution, for example improving or replacing hashing techniques for different components without breaking compatibility of tokens generated previously. For example, a prefix “g1” means that the token was generated with a first generation implementation of the tokenizer.

The encoding process is also referred to as “tokenization”. Tokenization is a modular technique which utilizes different hashing techniques, whose input is a set of relationship data with all of its components and whose output is a set of encoded tokens. A tokenizer of a specific generation applies a concrete hashing technique to each component and produces an intermediate output referred to as a hash tree. The hash tree is then flattened into a set of tokens. A single set of relationship data may and often will produce multiple tokens of varying match power, where the match power defines a maximum score that an exact match on a given token can produce.

A hash tree is a generalized output of the tokenization process and as such is a concept shared by all generations of tokenizers.

A hash tree is illustrated in FIG. 3A. In the tree, “anchor” nodes (e.g. anchor node 302a) represent data of consent givers and “root” nodes (e.g. 304a-304b) and “leaf” nodes (e.g. 306a-306c) represent different data components for consent subjects associated by way of the consent relationship with the consent givers. The tree is built during tokenization and then flattened into a set of tokens 308a-308c.

Each anchor, root and leaf node includes a hash value derived from a particular component of the relationship data. This is illustrated in FIG. 3B which shows hash values generated for different data elements. The hash tree is flattened by concatenating the hash values along a path from an anchor node to a leaf node, resulting in a set of complete tokens 310. As shown, each token is prefixed by a generation prefix (here “g1:”) indicating the version of the tokenizer used to encode the token. FIG. 3B also illustrates that different tokens may be associated with different match powers as discussed in more detail below.

In an embodiment, anchor hashes encode the unique identifier of the consent giver (e.g. parent) identifier, root hashes encode the date of birth of the consent subject (e.g. child) and leaf hashes encode the name of the consent subject (e.g. child).

An example implementation of the tokenizer will now be described. However, it will be readily appreciated that different implementations of the tokenizer may be used, and the same system may support different tokenizer implementations by way of the generation prefix.

The tokenizer uses strong non-malleable hashes for anchors as well as roots.

Root hashes encode date of birth data. However, if only the date itself was used the input space would be very small, which could make it possible for someone to generate all possible hashes and so reverse the information. In order to avoid this, the input of the root hash is mixed with the anchor hash itself. This means that new roots need to be created for the same date of birth in combination with each different anchor but in return this makes the input space sufficiently large and unpredictable so that reversibility becomes impossible.

Having strong anchors and root hashes allows for the leaves to be somewhat malleable because they are always attached to a very specific anchor-root branch. Accepting malleable leaves gives an opportunity to implement hashes that are locality-sensitive so they can be used to hash names with certain fuzziness, such that small typographical errors will produce very similar hashes to the correctly spelled name. To further take advantage of strong root hashes it is possible to compress the output space of the leaf hashing to deliberately increase the number of collisions and so prohibit reversibility while still preserving the local sensitivity used for fuzzy matching. The overall result is a hash tree which is very strong, i.e. practically impossible to reverse back to original data, has a very small likelihood of malignant collision and at the same time has a good local-sensitivity on the name component.

In this approach, the consent giver identifier and consent subject date of birth must match precisely when matching a relationship assertion because they are used as the non-malleable branches but the consent subject name allows for inexact (fuzzy) matching.

The non-malleable hashes are implemented by way of standard hash functions. Fuzzy name matching for the name component is enabled by a custom-designed hash function. This hashes each individual name component (first name, middle names, surname) separately which ensures that order of names is not relevant, i.e. “Adam Smith” or “Smith Adam” produces the same hash result. Furthermore, the hash for each name component is generated based on a weighted sum of constituent letter values, with the letters appearing earlier in a name component given a higher weight than letters appearing later in the name component. This means that an error in the first letter, e.g. “Xdam Smith” produces a hash with larger distance from the correct original than an error in the middle or at the end of the word, e.g. “Adan Smith”. Missing or extra accents are considered letter errors for this purpose.

The tokenization process is summarized in FIG. 4. Example algorithms for generating the hashes at each stage are set out below.

Generally, the tokenization involves pre-processing the data components of the relationship data, and then applying one or more hash functions. In particular, individual components of relationship data are preferably normalized prior to application of the hash functions, e.g. by removing whitespace, placing data into standard formats (e.g. standard telephone number or date-of-birth formats), converting data to a consistent case (e.g. all upper case or all lower case), and the like.

In step 402, the anchor hash is generated based on the unique identifier of the consent giver. An example algorithm used in an embodiment is as follows:
Anchor (consent giver ID)=AES256 (normalized consent giver ID)
   a. normalize consent giver ID by:
      i. removing all spaces
      ii. detecting whether consent giver ID is email address or phone number. if phone number, then:
         1. insert default international code if local number
         2. replace +XX format with 00XX format of international codes
         3. remove redundant 0 between international code and local network prefix
         4. remove all non-numeric characters
   b. apply AES256 checksum to the normalized consent giver ID
   c. prefix with generation tag e.g. “g1:”
EXAMPLE INPUT ID: +44(0)7333 452934
->normalize->00447333452934
->checksum and prefix
->
g1: 07eb5de568abbde396ec20264c88ac5fd9ae7183c5ecd5ce94ae48 b5e66f212d

Note that other normalization steps may be employed, such as converting email addresses to a consistent case (e.g. all lower or upper case).

Steps 404 and 406 generate hashes based on the consent subject data. In step 404, the root hash is generated based on the date of birth of the consent subject, for example using the following process:
32-bit Root Hash=FNV1a (AES256 (anchor+normalized date of birth))
   a. normalize date of birth to a consistent date format (e.g. remove slashes or other separators and express date and month as two digits and year as four digits, for example using ddmmyyyy or other fixed format)
   b. prefix with anchor hash (computed in step 402)
   c. apply AES256 checksum to the concatenated anchor hash and normalized date of birth
   d. apply FNV-1a (variant of the Fowler-Noll-Vo hash function) to the AES256 checksum computed in step c.
EXAMPLE DATE OF BIRTH: 05.05.2009 AND THE ANCHOR FROM THE EXAMPLE ABOVE
->normalize date of birth->05052009
->fnvla(aes256(anchor+05052009))->193cbd77

In step 406, the leaf hash is generated based on the name of the consent subject:
32-bit Leaf Hash:
   a. Convert name to lowercase and split into a set of single name components, e.g. first, middle, last name
   b. Calculate local hash for each name component:
      i. Initialise local hash value to zero and set initial weight of a letter to 65535
      ii. iterate over utf-8 character values of the characters in the name component and calculate:
         1. utf-8 character code multiplied by weight
         2. add result to the local hash value
         3. divide weight by 4
         4. repeat for the next character until all letters added
   c. sum up local name hashes for each name component into a final numeric hash of the name
   d. hex encode the final numeric hash
EXAMPLE NAME: Elsie Allen
->lowercase and split-> [elsie, allen]
->calculate local hashes-> [8992494, 8699892]
->sum local hashes->17692386->hex->010df6e2

In step 408, the hashes in the hash tree are concatenated as previously describe to generate a set of flattened tokens. The tokens are then stored in the database in step 410 and can then be compared to corresponding tokens generated from a relationship assertion using the same encoded process.

Multiple leaf nodes may be created for the same anchor/root pairing which can provide different ways for matching a child to a parent. In an example, different leaves associated with the same root node can be used to encode the following possibilities:
a) name only,
b) date-of-birth only (in this case the name hash may be left blank, e.g. using a default value such as zero for the name hash, as depicted in FIG. 3C node 306a)
c) name and date-of-birth

Other leaf nodes could be created for other types of data, for example a child's email address or other identifying information. New types of leaf tokens may be introduced after deployment of the system by adding them to the client-side SDKs and server libraries.

When evaluating a relationship assertion, a corresponding token is generated using the same encoding process applied to the identifying information of the individuals between whom a consent relationship is asserted. The assertion token is then compared to the stored tokens; if the assertion token matches a stored token then the assertion is verified—i.e. the purported consent relationship matches a relationship fact stored in encoded form in the database and is thus considered valid; otherwise, the assertion fails.

### Graph Storage

In a refinement of the above approach, the token database is implemented using a graph data representation. A graph (being a set of nodes or vertices which may be interconnected by edges) provides a natural representation because the problem domain is a partial social graph of related individuals.

In an embodiment, nodes of the graph represent anchors (as discussed above), tokens (as discussed above) and data sources. In this approach, only the root and leaf nodes are flattened into tokens and are stored in the token nodes, linked in the graph by a graph edge to an anchor node, which contains the anchor hash. An example of the graph structure is shown in FIG. 5.

Here the graph includes, by way of example, an anchor token 502 which represents a particular consent giver and stores the hash of the consent giver identifying information (e.g. telephone number/email address), including tokenizer generation prefix, generated as discussed above (e.g. the hash from anchor node 302a in FIG. 3B). The anchor node is linked by a graph edge to token nodes, including token node 504. Token node 504 represents a consent subject in a consent relationship with the consent giver of anchor node 502 and stores a flattened token, where the flattened token comprises a concatenation of the root hash and an associated leaf hash (e.g. root hash 304a and leaf hash 306b of FIG. 3B). Thus, in this approach the tree structure of the Hash Tree is only partly flattened, with anchor nodes retained separately in the graph structure. However, alternatively, the “token” nodes could contain the full flattened tokens as illustrated in FIG. 3B including generation prefix and anchor hash (which would be repeated from the corresponding anchor node).

Different tokens generated from the same relationship data (e.g. representing date-of-birth only, name only, or date-of-birth plus name) are represented as different tokens (e.g. tokens 504, 508) linked to the same anchor node in the graph. Similarly, different relationship facts concerning the same consent giver are encoded as different token nodes linked to the same anchor node as long as they were generated using the same tokenizer generation.

Source nodes, e.g. node 506 identify the verification data sources from which the relationship data represented by particular tokens was obtained (e.g. using any suitable identifier of the verification data source).

In some embodiments, subsequent relationship assertions processed by the system may also be stored in the graph database, in which case a source node may also represent a source from which an assertion was received (e.g. a device/user identity). Storing assertions may allow subsequent assertions to be corroborated based on previous assertions (in which case only successful assertions may be stored) and/or may provide an audit trail e.g. to track fraudulent use.

In the graph, a token (representing a consent relationship with a particular consent subject) is always connected to one anchor (representing the consent giver) and source nodes are connected to tokens indicating the data source from which a particular token was derived (e.g. verification data source or earlier assertion). The same token may have multiple sources when the same relationship can be found in multiple data sources and assertions and the same anchor may have multiple tokens representing multiple relationship facts or assertions related to the individual (consent giver) represented by the anchor.

The anchor nodes are indexed in the graph database to enable efficient searching. This means that a verification (or other search or query) starts with a known anchor from where connected tokens can be found.

As mentioned above, the tokenizer implementation, e.g. the concrete set of hash functions used, can evolve over time to improve the desired properties (fuzziness and non-malleability) so the anchors are prefixed with the generation prefix which means that an anchor and its tokens generated by different tokenizer generations form separate subgraphs of nodes in the stored graph.

As discussed above, the source data may indicate different relationship types. In the described embodiment, the relationship type is not explicitly encoded in the final graph and the graph merely indicates that the consent giver has sufficient authority with regard to the consent subject (e.g. child or self) to provide consent. However, in other application domains, different types of relationships, e.g. different consent authority levels, could be encoded explicitly in the tokens/graph.

In preferred embodiments, tokenization is performed at the source system as previously described. Referring back to FIG. 1, this is implemented by way of an import service 112 which periodically examines data in the data source to identify whether any new relevant relationship data has been added. When new relationship data is found, the data is encoded using the tokenization process. This occurs at the verification data source, so that only the encoded tokens are sent across the network to the verification service 100. Note the import service 112 may transmit separate anchor/root/leaf hash values, or may transmit an anchor hash and a separate token consisting of root and leaf hashes ready to be stored in graph database 102. Alternatively, the encoder may create fully flattened tokens as shown in FIG. 3B, which may be separated by import interface 106 into anchor hash and root+leaf tokens for storage in the graph database. Because anchor hashes are preceded with a tokenizer generation prefix, different data sources/import services can in principle be using different tokenizer implementations concurrently, but matching is generally only possible where relationship facts and assertions were encoded using the same implementation.

Implementing the tokenization at the verification data sources (e.g. on the same server or in the same local network as the verification data source, typically behind a firewall protecting the local network) can ensure that only encoded information leaves the verification data source or associated network location. On transmission, the encoded information has been processed by the tokenization algorithm using the various one-way hash functions to render the source information essentially unrecoverable from the encoded information. This ensures that potentially sensitive personal information is not exposed outside the verification data source, its local network and/or the control of the owner/operator of the data source.

In preferred embodiments, for the same reasons, the tokenization of relationship assertions submitted for verification is also performed locally at user devices (via encoder 120) and/or external systems (by way of encoder 116). By performing all encoding locally, only encoded hash values/tokens pass over the network. The verification service 100 only stores and processes encoded information (in the form of the hash values/concatenated hash tokens) from which source information (e.g. personal contact details, names etc) cannot be recovered, ensuring security and data privacy.

However, in other embodiments, external systems and/or user devices could submit unencoded assertions, with the tokenization performed at the verification service 100 instead (though usually undesirable, this could in principle also apply to verification data sources if the data is not considered sufficiently sensitive or its security is ensured in other ways).

FIG. 6 illustrates a process for performing verification of a relationship assertion using the graph database.

In step 602 a relationship assertion is generated. This may be generated e.g. via an external system 114 or user device 118. For example, a user may use the application on the user device to authenticate themselves as a user of the verification system, and supply relevant identifying information of a parent and child (e.g. parent telephone number, child date of birth and name). The tokenization is then performed (preferably locally at the user device) to generate the hash tree (step 604) and derive the anchor hash and the token consisting of the root and leaf hashes (step 606) as previously described. The anchor hash and token are then transmitted to the verification service in a verification request. The request is received at the verification service in step 608.

In step 610, the graph database is searched based on the anchor hash. This step uses a database index defined on the anchor hashes for efficiency. If no matching anchor node is found in the graph (test 612) the process determines that the assertion has failed (step 620), since there are no relationship facts matching the assertion stored in the database.

If a matching anchor node is identified, then the process identifies token nodes linked in the graph to the identified anchor node and compares the received token to the tokens stored in the identified token nodes (step 614). If one of the token nodes matches the token derived from the assertion (test 616), then the assertion is deemed successful (618), since there is a relationship fact encoded in the graph that matches the relationship assertion. If none of the token nodes linked to the anchor node match the token derived from the assertion, then the assertion is considered to have failed (step 620). Steps 618/620 of the process output an indication indicating whether the assertion was successful or not. For example, the verification result may be transmitted in a response message to the requesting system or device, and/or may be stored for later retrieval by another system.

As discussed previously, while some components of the identifying information may be encoded so as to require an exact match, other components (e.g. child name) may allow for fuzzy matching, by way of an encoding where two similar inputs generate numerically close hash values, whilst dissimilar inputs generate hash values that are not close. This allows the system to allow for spelling variations or typographical errors in names. When using this approach, when comparing tokens in step 614, the system may instead compute a distance between the token generated from the assertion and each of the stored tokens. For example, the distance can be computed simply as the (numerical) difference or absolute difference between assertion token and stored token (noting that the “name” hash appears at the end of the token, forming the least significant bits of the token). However, other approaches could be used to determine token distance.

The difference can then be compared to a threshold to determine a match. For example, if the difference exceeds the threshold it is considered a mismatch but if the token difference is less than (or equal) to the threshold, then it is considered to match.

In embodiments this approach may be extended to support matches of varying match power. For example, when comparing tokens, the system may search for matches to the whole token, but also identify tokens where only one or more hash components of the token match (e.g. the root hash based on date of birth or the leaf hash based on name). It will be noted that the individual hash components (anchor hash, root hash, leaf hash) have fixed known sizes, which allows the system to match components individually. In one example, match power may be determined as follows:
match on name only is power 1 if the match is not exact (i.e. contains a certain amount of fuzzy distance, not exceeding a match threshold) or 2 if exact match
exact match on date of birth only has power of 3
match on exact date of birth and fuzzy match on name is power 4
match on exact date of birth and exact name is power 5

As before, for the name component, if the distance between the name hashes in the stored token and assertion token exceeds a threshold this is considered a mismatch. Thus, a zero distance is considered an exact match; a token distance up to the threshold is considered a fuzzy match, and a distance exceeding the threshold is classified as a mismatch for the name hash component.

Where match power is determined, a successful assertion output 618 may be accompanied by an indication of the match power. This approach may be used to determine a level of confidence in a match. Any further process or system relying on the verification output can use the match power to determine how to proceed (e.g. refuse access or consent or require additional verification in the case of a match with low match power).

### Consent Management

Embodiments may integrate the above verification process into a consent management system in which parents can grant, manage and revoke consent for their children to access services and for the services to handle data obtained and generated through use of the services by the children.

FIG. 7 illustrates a system in overview, in which users can interact with a consent management system 712 over network 710 (e.g. the Internet, mobile telephony networks etc.) using an interface accessed through a web browser 702 (running a web front end to the system), a desktop application 704 and/or a mobile application 706 running on a mobile user device, such as a smartphone.

The consent management system 712 maintains user accounts for users (typically parents). When setting up an account, a parent provides the unique identifying information discussed previously (such as telephone number and/or email address) on which relationship assertions can be based. Those details can be verified as associated with the user by conventional means, such as transmitting a verification code required to complete registration to the telephone number/email address.

Subsequent access to the system can be controlled using conventional user authentication techniques (e.g. via login credentials such as username and password).

Once the user is logged in and authenticated, a user can then add information specifying the child or children for whom they are responsible. The user can set up separate records for different children. For each child, the user provides one or more pieces of identifying information used in formulating relationship assertions as discussed above, such as date of birth and name. The consent management system 712 then formulates a relationship assertion as described and submits it to the verification service 100 which returns an indication whether the assertion could be verified or not. Assuming the verification service successfully verifies the asserted relationship based on its database of relationship facts, the consent management service 712 can record the verified consent relationship and can then allow the user to set up, manage and revoke consent for the child in relation to various online services.

For example, the parent may configure consent via the mobile application or other interface for a specific service by identifying the service (e.g. selecting it from available services) and indicating that the child has consent to access the service and/or that the service has consent to manage data for the child in accordance with the relevant data protection regulations. The parent may similarly deny consent or revoke previously given consent via the interface. Consent records identifying consent provided (and/or denied/revoked where applicable) are stored in a consent database 714.

Third-party data processing services 716 using the system can request the consent status for a child seeking to use their services via a separate interface to determine whether to deny or allow access and how to manage personal data for the child.

In one approach, such third-party services may proactively make a request to the system 712 for consent to be obtained (if not already provided), for example in response to a child attempting to use a service. In that case, the consent management system records the request, and prompts the parent (e.g. via email/text message or through the application) to review and action the consent request. Once the parent accesses the system and provides (or denies) the requested consent, the third-party service can then proceed as appropriate, e.g. by allowing access to the child to the service.

An example process flow for consent management is illustrated in FIG. 8.

In step 802, a child seeks access to a data processing service, such as an online gaming platform or other online system or service. The child provides identifying information for themselves (e.g. name and date of birth) and the parent (e.g. email address/phone number). The data processing service then sends a consent request to the consent management system (CMS) in step 804.

In step 806, the CMS sends a consent request to the parent, either directly using the identifying information for the parent, or by identifying an existing parent account in the system and notifying the parent via contact details stored in the parent account, or directly through notification in the client application. Note that, if at this stage the CMS identifies that consent has already been granted for the child (based on stored consent records), the system may simply return an indication of consent to the online service, skipping step 806 and subsequent steps.

In step 808 the parent logs into the client application for the CMS. If the parent is not already a registered user of the system, the parent may be prompted at this point to set up an account, download the client application etc.

Assuming the child has not been added to the system, the parent supplies any necessary identifying information for the child in step 810. The client application then generates an encoded relationship assertion and submits it to the verification service as previously described (alternatively this step could be performed at the consent management system). If the child was previously registered on the parent account and the consent relationship between parent and child was already verified, steps 810-814 may be omitted. Alternatively, the verification of the consent relationship may be repeated for each new consent request, or periodically.

If verification of the asserted consent relationship is successful (test 814) or not required (e.g. because the parental relationship was previously successfully verified and recorded on the parent account), then the application asks the parent to provide (or deny) consent for the child to access the service and/or for data handling by the service (step 816). The specific consent being requested may be specified in the original consent request from the data processing service. The parent then inputs an indication that consent is granted or refused via the application interface.

The consent management service then sends a response to the consent request to the data processing service, notifying the data processing service of the result of the consent request. The response may include a control indication stating the status of consent (granted/denied) and the verification result for the consent relationship. In one example, control information is provided indicating verified consent when the consent relationship was verified and a positive consent indication was received from the parent. On the other hand, if the verification of the consent relationship failed, a positive consent indication from the parent was not received, or a negative consent indication was received, then the control information indicates absence of verified consent. The control information may alternatively or additionally be stored for future retrieval by the data processing service.

If verified consent was granted (test 818), the data processing service then grants access to the service by the child (820). On the other hand, if consent was not granted, then access to the service by the child is denied (822). Access is also denied if the consent relationship verification was not successful in step 814 (since the user, e.g. purported “parent”, is deemed unable to provide consent if the consent relationship could not be verified). Instead of denying access, other actions may be taken at the data processing service, e.g. limiting access and/or data collection and processing, depending on the type of consent sought.

The granted (or denied) consent is stored as a consent record in the consent database. Each consent record identifies the service, the child and the consent status (including verification status). The nature/type of consent may also be indicated.

The system thus allows a parent to manage consent independently for different children and/or for different services. In some cases, services may support different consent levels or consent types and/or consent for different services provided by a given provider, allowing more granular control of consent (e.g. separate consent for the same service could be provided/denied to access a service, consume content, upload content, purchase content etc.) Consent levels may also be defined, e.g. corresponding to age ratings (e.g. consenting to access by a child to content rated for a particular age group but not other age groups). Furthermore, data handling consent granted to the service may represent a separate type of consent from access/usage consent.

In one example, the system may store information on different services, identifying a provider and one or more specific services provided by the provider, the type of consent required for the service, and possibly other information such as an age requirement, description, and URL links to the service. Consent records can then be defined for those services. Each consent record may identify the child username, provider and service, consent status (e.g. pending, granted, denied, revoked), contact details of the parent form whom consent is being requested, request/update timestamps, and the verification status (e.g. indicating that the consent relationship verification succeeded or failed).

The parent user can use the application interface to view all consent records for their child/children, and to update consent status. For example, the user can view pending consent requests and grant or deny a request as needed. The user can also view existing granted consent instances and can revoke any consent given for a particular service at any time. In that case, the CMS may notify the online service in question of the consent withdrawal.

For example, in the case of data handling consent, the parent may decide to revoke the consent previously given at some later time. The service is then notified that there is no longer consent for the service to store and process data associated with the child. In response, the service can delete the child's data and/or take any other steps required for compliance with the applicable data protections regulations. In the case of a revoked access consent, the service may deny future access attempts to the service and/or terminate an existing session where a child is currently using the service.

The application interface also allows the parent to update their own data (e.g. contact information), child data and to add/remove children as needed.

While described mainly in relation to the mobile application 706, alternative interfaces such as web front end 702 in a browser or a desktop application 704 may be provided implementing equivalent functionality.

Furthermore, the workflow of FIG. 8 represents just one example of possible workflows that may be implemented. For example, instead of waiting for a child to attempt access to a data processing service to trigger the consent workflow, a parent may proactively configure consent for the service via the consent management interface, before the child attempts to use the service. Later, when access is attempted, the data processing service can then retrieve the configured consent status by querying the consent management system, and control usage by the child in accordance with the retrieved consent status, without requiring further interaction by the parent.

### Server Device

FIG. 9 illustrates a server 900 that may be used to implement the verification service 100 of FIG. 1.

The server includes one or more processors 902 together with volatile/random access memory 904 for storing temporary data and software code being executed.

A network interface 906 is provided for communication with other system components (e.g. verification data sources 110, external systems 114, user devices 118 and consent management system 712) over one or more networks 710 (e.g. Local or Wide Area Networks, including the Internet).

Persistent storage 908 (e.g. in the form of hard disk storage, optical storage and the like) persistently stores software and data for implementing the described functions, including import interface 106 for importing relationship data from verification data sources 110, external API 104 for communicating with external systems 114, device API 108 for communicating with user devices 118, verification process 910 for receiving and evaluating relationship assertions, and graph database 102 for storing relationship data (including relationship facts obtained from verification data sources, and past relationship assertions). The persistent storage also includes other server software and data (not shown), such as a server operating system.

The server will include other conventional hardware and software components as known to those skilled in the art, and the components are interconnected by one or more data busses (e.g. memory bus, I/O bus etc.)

While a specific architecture is shown by way of example, any appropriate hardware/software architecture may be employed.

Other components in the system such as user devices, external systems, and the consent management system may similarly be implemented using conventional computing devices and/or server hardware.

Functional components indicated as separate may be combined and vice versa. For example, the functions of server 900 may in practice be implemented by multiple separate server devices (e.g. as a cluster of servers). The database 102 may be stored within the server(s) or in one or more separate database servers. Functions of the verification service 100/server 900 and the consent management system 712 could also be integrated in a single server of group of servers.

It will be understood that the present invention has been described above purely by way of example, and modification of detail can be made within the scope of the invention.

1. A computer-implemented method of controlling, based on verified consent obtained from a first individual, operation of a data processing service in relation to usage of the data processing service by a second individual, the method comprising:
storing in a database a set of encoded relationship facts, each relationship fact specifying a consent relationship between two individuals identified by respective identifying information, wherein the relationship facts are encoded using an encoding process that applies one or more one-way functions to the identifying information such that the identifying information is substantially irrecoverable from the encoded relationship facts;
receiving a request specifying an asserted consent relationship between the first individual identified by first identifying information and the second individual identified by second identifying information;
applying the encoding process to the first and second identifying information to generate an encoded relationship assertion;
determining whether the encoded relationship assertion matches an encoded relationship fact in the database; and
controlling operation of the data processing service in dependence on the determination.

2. A method according to claim 1, wherein each encoded relationship fact comprises one or more hash values generated by the encoding process, wherein applying the encoding process comprises generating one or more hash values from the first and second identifying information for the asserted consent relationship, the determining step comparing the generated hash value(s) to the hash value(s) of the relationship facts stored in the database.

3. A method according to claim 1, wherein the database stores for each encoded relationship fact:
a first encoded element, comprising one or more hash values obtained by encoding identifying information associated with a consent giver individual using one or more one-way functions;
a second encoded element, comprising one or more hash values obtained by encoding identifying information associated with a consent subject individual using one or more one-way functions; and
an association linking the first encoded element and the second encoded element, the association identifying a predetermined consent relationship between the first and second individuals.

4. A method according to claim 3, comprising generating for the asserted consent relationship, corresponding first and second encoded elements, the determining step comprising:
searching in the database for a first encoded element matching the first encoded element of the asserted consent relationship;
in response to identifying the first encoded element, searching the database for a second encoded element linked to the first encoded element by an association indicating a consent relationship and matching the second encoded element of the asserted consent relationship; and
identifying the asserted consent relationship as a verified consent relationship in response to finding the matching first and second encoded elements in the database.

5. A method according to claim 3, wherein the database comprises a graph data structure linking each of a plurality of first encoded elements corresponding to identifying information of consent givers to one or more second encoded elements corresponding to identifying information of consent subjects.

6. A method according to claim 5, comprising further linking encoded elements, preferably consent subject elements, to source elements in the graph, the source elements indicating data sources from which encoded consent relationships represented in the graph were obtained.

7. A method according to claim 1, wherein the encoding process comprises, for a given first individual being a consent giver and a given second individual being a consent subject:
applying a first one-way function to identifying information associated with the first individual to generate a first hash value; and
applying one or more further one-way functions to identifying information associated with the second individual to generate one or more further hash values.

8. A method according to claim 7, comprising one or both of:
generating a consent giver hash from the first hash value, optionally by concatenating the first hash value with an identifier identifying a version of the encoding process used;
concatenating the further hash values to form a consent subject token representing the identifying information for the second individual.

9. A method according to claim 8, wherein the database associates a consent giver hash with one or more consent subject tokens indicating consent relationships between the consent giver and the consent subject(s).

10. A method according to claim 7, wherein at least one of the further one-way functions is applied to identifying information associated with the second individual combined with the first hash value generated by the first one-way function.

11. A method according to claim 10, comprising:
generating a second hash value from a combination of the first hash value and a first piece of identifying information of the second individual;
generating a third hash value from of a second piece of identifying information of the second individual; and
combining the second and third hash values to generate a hash token representing the consent subject.

12. A method according to claim 11, wherein:
the identifying information associated with the first individual comprises a unique identifier of the first individual, optionally a communications identifier such as a telephone number or email address; and/or
the first piece of identifying information of the second individual is a date of birth of the second individual; and/or
the third piece of identifying information comprises a name of the second individual.

13. A method according to claim 7, wherein at least one hash value, preferably the third hash value, is generated using a one-way function, preferably comprising a malleable hash function, whose output values are numerically closer for similar inputs than for dissimilar inputs.

14. A method according to claim 1, wherein identifying information to which the encoding process is applied comprises a name having multiple name components, the encoding process applying a one-way function to the name whose output is invariant for variations in the order of the name components.

15. A method according to claim 1, wherein identifying information to which the encoding process is applied comprises a name, wherein the one-way function applied to the name comprises computing a weighted sum of character values of the characters in the name, wherein the weighted sum preferably applies a higher weight to characters that appear earlier in the name than to characters that appear later in the name.

16. A method according to claim 15, wherein identifying information to which the encoding process is applied comprises a name having multiple name components, the method comprising computing individual weighted sums for each of a plurality of name components and generating the hash value based on combining, optionally summing, the individual weighted sums.

17. A method according to claim 1, wherein the encoding process applies a non-malleable hash function to at least one element of identifying information, the at least one element optionally comprising identifying information of the first individual.

18. A method according to claim 1, wherein the encoding process comprises normalizing identifying information before applying a one-way function, wherein normalizing optionally comprises one or more of:
removing one or more whitespace characters;
converting letter characters in the identifying information to a consistent case;
formatting the identifying information in accordance with a predetermined character representation format, for example a predetermined date format or telephone number format.

19. A method according to claim 1, wherein the encoding process associates each encoded relationship fact or assertion with an encoding identifier specifying an encoding algorithm used to encode the relationship fact or assertion, wherein the determining preferably comprises comparing the relationship assertion to one or more relationship facts in the database having a matching encoding identifier, and wherein the encoding identifier optionally specifies a version of the encoding algorithm and/or identifies one or more hash functions used for generating encoded relationship facts or assertions.

20. A method according to claim 1, wherein the database is indexed based on hash values of identifying information associated with consent givers, the determining step preferably using the index to identify one or more encoded relationship facts matching a hash value generated by the encoding process from identifying information of the first individual.

21. A method according to claim 1,
wherein the encoded relationship facts are stored in the database under control of a consent verification system, the consent verification system performing the step of determining whether the encoded relationship assertion matches an encoded relationship fact in the database and providing a control indication indicating whether the asserted consent relationship was verified as matching a relationship fact or not in dependence on the determination; and
wherein the steps of receiving the request and applying the encoding process are preferably performed at a client system or device, the client system or device transmitting a query comprising the encoded relationship assertion to the consent verification system for verification over a data network.

22. A method according claim 21, comprising, at the consent verification system, receiving the encoded relationship facts from one or more verification data sources over a data network and storing the encoded relationship facts in the database, the method preferably further comprising, at a verification data source:
processing data in a database comprising personal information pertaining to individuals to identify consent relationships represented in the data;
applying the encoding process to identifying information for the individuals to generate one or more encoded relationship facts; and
transmitting the encoded relationship facts to the central verification system over a data network for storage in the database.

23. A method according to claim 1, wherein the controlling step comprises providing a control indication to the data processing service, the operation of the data processing service controlled in dependence on the control indication, wherein the control indication is determined in dependence on whether the encoded relationship assertion matches an encoded relationship fact in the database.

24. A method according to claim 23, comprising obtaining, via a consent management interface, an indication of consent from the first individual in relation to usage of the data processing service by the second individual, wherein the control indication is further determined in dependence on the indication of consent.

25. A method according to claim 23, wherein the control indication is determined to indicate:
verified consent in response to successful verification of the consent relationship and receipt of a positive consent indication from the first individual; and
absence of verified consent in response to at least one of:
failed verification of the consent relationship;
absence of a positive consent indication from the first individual;
a negative consent indication received from the first individual.

26. A method according to claim 21, wherein the controlling step comprises:
transmitting a message to the data processing service, the message including the control indication, and/or
storing the control indication for later retrieval by the data processing service;
the method preferably further comprising, at the data processing service, controlling usage of the data processing service by the second individual in dependence on the control indication, wherein controlling usage optionally comprises one or more of:
permitting or denying access to the service by the second individual in dependence on the control indication;
restricting usage of the service by the second individual in dependence on the control indication, optionally by restricting access to functions and/or content of the service; and
managing collection and/or storage of data pertaining to usage of the service by the second individual in dependence on the control indication.

27. A method according to claim 1, comprising, in response to verifying an asserted consent relationship between a consent giver and a consent subject, allowing the consent giver to manage stored consent indications indicating consent for usage of one or more data processing services by the consent subject, wherein managing stored consent indications optionally comprises granting, denying or revoking consent pertaining to usage of a data processing service by a consent subject.

28. A method according to claim 27, wherein consent indications indicate one or more of:
consent for a consent subject to access or use a data processing service or a part of the service;
consent for the data processing service to store and/or process information associated with usage of the service by the consent subject.

29. A method according to claim 27, comprising providing a consent indication to a data processing service in response to a query from the data processing service, wherein the query is optionally generated by the data processing service in response to a consent subject attempting to access or use the service.

30. A method according to claim 27, comprising:
receiving from a consent giver an indication to revoke consent for a consent subject relating to a data processing service;
in response, transmitting a message to the data processing service indicating the revoked consent;
and preferably further comprising, at the data processing service, controlling access or data processing relating to the consent subject in dependence on the received message, optionally by one of: denying future access to the service, and deleting data associated with the consent subject.

31. A method according to claim 1, wherein consent relationships comprise parental relationships, wherein a parental relationship indicates a consent relationship between a parent or legal guardian as consent giver and a child as consent subject.

32. A system having means, optionally in the form of one or more processors and memory storing software code for execution by the processor(s), for performing a method as set out in claim 1.

33. A system for verifying consent relationships, comprising:
a database storing a set of encoded relationship facts, each relationship fact specifying a consent relationship between two individuals identified by respective identifying information, wherein the relationship facts are encoded using an encoding process that applies one or more one-way functions to the identifying information such that the identifying information is substantially irrecoverable from the encoded relationship facts;
a request interface configured to receive a verification request, the verification request including an encoded consent relationship assertion asserting a consent relationship between a consent giver and a consent subject, the encoded assertion generated by applying the encoding process to identifying information associated with the consent giver and the consent subject; and
a request processing module configured to:
determine whether the encoded relationship assertion matches an encoded relationship fact in the database; and
in response to determining that the encoded relationship assertion matches an encoded relationship fact in the database, outputting a control indication indicating successful verification of the asserted consent relationship;
the system optionally further comprising means for performing or participating in a method according to claim 1.

34. A tangible computer-readable medium comprising software code adapted, when executed by one or more processing devices, to perform a method as set out in claim 1.
